(19) United States
(12) Patent Application Publication
(10) Pub. No.: US 2009/0055033 A1
(43) Pub. Date: Feb. 26, 2009

(54) APPARATUS AND METHODS FOR FAULT DETECTION AT VEHICLE STARTUP

(75) Inventors: Michael T. Gansler, Candia, NH (US); Michael F. Kaufman, New Boston, NH (US)

Correspondence Address: PROSKAUER ROSE LLP, ONE INTERNATIONAL PLACE, BOSTON, MA, 02110, US

(73) Assignee: Segway Inc.

(21) Appl. No.: 11/843,689

(22) Filed: Aug. 23, 2007

(51) Int. Cl. G06F 7/00

(52) U.S. Cl. 701/1

(57) ABSTRACT

A method for initializing a controller of a balancing transporter involving acquiring a plurality of orientation signals associated with the balancing transporter. The method also involves determining if one or more of a plurality of angular rate sensors has a signal output offset below a threshold based on the plurality of orientation sensor signals. The method also involves initializing a pitch state estimator for controlling operation of the balancing transporter based on output of the one or more of the plurality of angular rate sensors. The method also involves controlling operation of the balancing transporter based on at least one output of the pitch state estimator.

### FIELD OF THE INVENTION

The present invention pertains to control of transporters, and more particularly to methods and apparatus for detecting fault conditions in sensors used to control operation of the transporters.

### BACKGROUND OF THE INVENTION

Dynamically stabilized transporters refer to vehicles having a control system that actively maintains the stability of the transporter while the transporter is operating. The control system maintains the stability of the transporter by continuously sensing the orientation of the transporter, determining the corrective action to maintain stability, and commanding the wheel motors of the transporter to make the corrective action. If the transporter loses the ability to maintain stability, such as through the failure of a component, the rider may experience discomfort at the sudden loss of balance. Vehicles of this sort may be more efficiently and safely operated when they employ system architectural features supplementary to those described in the prior art.

### SUMMARY OF THE INVENTION

The invention, in one aspect, features a method for initializing a controller of a balancing transporter. The method involves a) acquiring a plurality of orientation signals associated with the balancing transporter. The method also involves b) determining if one or more of a plurality of angular rate sensors has a signal output offset below a threshold based on the plurality of orientation signals. The method also involves c) initializing a pitch state estimator for controlling operation of the balancing transporter based on output of the one or more of the plurality of angular rate sensors. The method also involves d) controlling operation of the balancing transporter based on at least one output of the pitch state estimator.

In some embodiments, the method involves terminating step c) if one or more of the angular rate sensors has a signal output offset at or above the threshold. In some embodiments, step b) involves comparing each of the orientation signals to a corresponding threshold value. In some embodiments, initialization of the pitch state estimator is terminated if one or more of the orientation signals equals or exceeds its corresponding threshold value. In some embodiments, the method involves repeating a), b), c) and d) until the signal output offsets of the angular rate sensors are below the threshold.

In some embodiments, step b) involves determining if pitch or roll of the transporter varies by more than 1.5 degrees over a predetermined period of time, the pitch and roll are estimated based on accelerometer output signals. In some embodiments, step b) involves determining if yaw rate of the transporter varies by more than 4.7 degrees per second over a predetermined period of time, the yaw rate is estimated based on difference in speed of left and right ground-contacting elements of the transporter that apply torque to an underlying surface of the transporter. In some embodiments, step b) involves determining if speed of a left or right ground-contacting element of the transporter exceeds 0.22 meters per second, the left and right ground contacting elements apply torque to an underlying surface of the transporter. In some embodiments, step b) involves determining if the difference between a first yaw rate signal and a second yaw rate signal is greater than 22 degrees per second, the first yaw rate signal is estimated based on difference in speed of left and right ground-contacting elements of the transporter that apply torque to an underlying surface of the transporter and the second yaw rate signal is based on angular rate signals output by two or more of the plurality of angular rate sensors, the angular rate signals corresponding to angular rate around a transporter-fixed substantially vertical axis.

The invention, in another aspect, features a balancing transporter that includes a plurality of devices (e.g., sensors) for providing orientation signals associated with the balancing transporter. The transporter includes a plurality of angular rate sensors. The transporter includes a processor for determining if one or more of the plurality of angular rate sensors has a signal output offset that equals or exceeds a threshold based on the orientation signals and for estimating a pitch state of the balancing transporter based on output of two or more of the plurality of angular rate sensors. The transporter also includes a controller for controlling operation of the balancing transporter based on the pitch state estimate.

In some embodiments, the processor determines if one or more of the angular rate sensors has a signal output offset that equals or exceeds a threshold by comparing each of the orientation sensor signals to a corresponding threshold value. In some embodiments, the transporter includes at least one ground-contacting element for applying torque to an underlying surface of the transporter.

The foregoing and other objects, aspects, features, and advantages of the invention will become more apparent from the following description and from the claims.

### BRIEF DESCRIPTION OF THE DRAWINGS

The foregoing features of the invention will be more readily understood by reference to the following detailed description, taken with reference to the accompanying drawings, in which:

FIG. 1 is a schematic illustration of one embodiment of a transporter to which the present invention may be applied.

FIG. 2 is a block diagram of a control loop for dynamically controlling the stability of a vehicle in the fore-aft plane, for an illustrative embodiment of the invention.

FIG. 3A is a diagram showing a land-based vehicle and corresponding vehicle frame (V-frame) coordinate axes in the presence of a pitch angle along with the Earth frame (E-frame) coordinate axes of the earth.

FIG. 3B is a diagram showing the relation of the E-frame to the V-frame when the pitch angle is zero and the roll angle is non-zero.

FIG. 4 is a schematic clock diagram of a portion of the system architecture used to control a transporter, according to an illustrative embodiment of the invention.

FIG. 5 is a functional block diagram for a three axis state estimator module, according to an illustrative embodiment of the invention

FIG. 6 is a schematic illustration of a control system for a transporter, according to an illustrative embodiment of the invention.

FIG. 7 is a flow diagram of a method for initializing a controller of a balancing transporter, according to an illustrative embodiment of the invention.

### DETAILED DESCRIPTION OF ILLUSTRATIVE EMBODIMENTS

A transporter may be said to act as ‘balancing’ if it is capable of operation on one or more wheels but would be unable to stand on the wheels but for operation of a control loop governing operation of the wheels. A balancing transporter lacks static stability but is dynamically balanced. A transporter may advantageously be used as a mobile work platform or a recreational vehicle such as a golf cart, or as a delivery vehicle. The wheels, or other ground-contacting elements, that provide contact between such a transporter and the ground or other underlying surface, and minimally support the transporter with respect to tipping during routine operation, are referred to herein as ‘ground-contacting elements.’

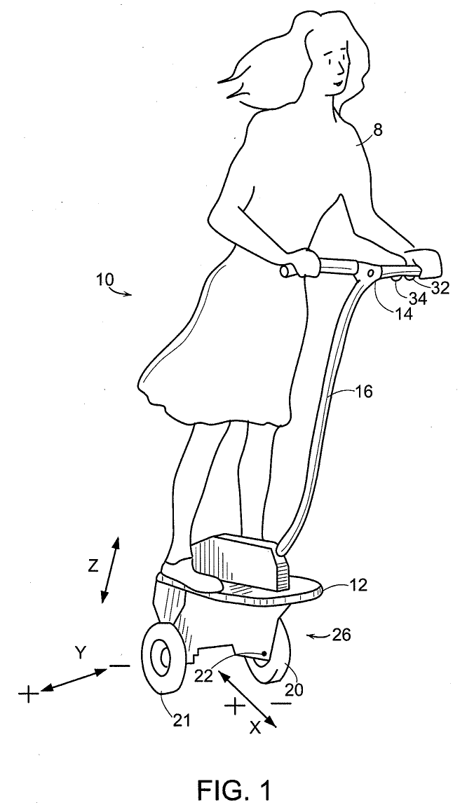

FIG. 1 shows a balancing transporter, designated generally by numeral 10, and described in detail in U.S. Pat. No. 6,302,230 (which is hereby incorporated by reference), as an example of a device to which the present invention may advantageously be applied. A subject 8 stands on a support platform 12 of ground-contacting module 26. The subject 8 holds a grip 14 on a handle 16 attached to the platform 12. Wheels 21 and 22 are coaxial about the Y axis. Steering or other control may be provided by thumbwheels 32 and 34, or by other user input mechanisms. In some embodiments, steering or control of the transporter 10 is performed using a twist-grip mechanism in the grip 14 of the transporter 10. In some embodiments, steering or control of the transporter 10 is performed by a user causing the handle 16 of the transporter 10 to lean (e.g., change in angle) with respect to one or more axes (X, Y and Z) of the transporter 10.

A control loop may be provided so that leaning of the subject results in the application of torque to wheel 20 and/or wheel 21 about axle 22 by means of a motor drive. The transporter 10, however, is statically unstable, and, absent operation of the control loop to maintain dynamic stability, transporter 10 will no longer be able to operate in its typical operating orientation. “Stability” as used herein, refers to the mechanical condition of an operating position with respect to which the system naturally returns if the system is perturbed away from the operating position in any respect.

The transporter 10 may be operated in a station-keeping mode, wherein balance is maintained substantially at a specified position. Additionally, the transporter 10, which may be referred to herein, without limitation, as a “vehicle,” may also maintain a fixed position and orientation when the user 8 is not on the platform 12. This mode of operation prevents runaway of the transporter 10 and provides for the safety of the user and other persons. In one embodiment, the transporter 10 is operated in the station-keeping mode while the user is stepping on to the platform 12 of the transporter 10. In some embodiments, a force plate or other sensor (not shown) disposed on the platform 12 is used to detect the presence of a user on the transporter 10.

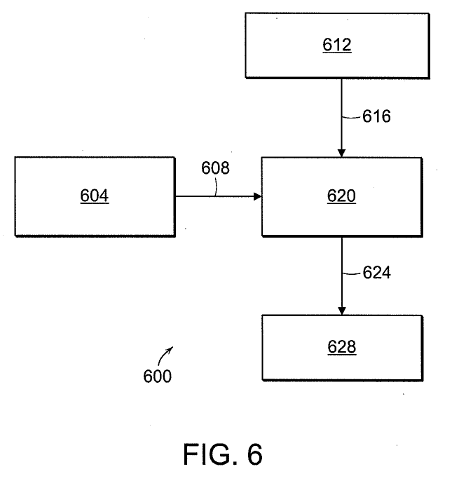

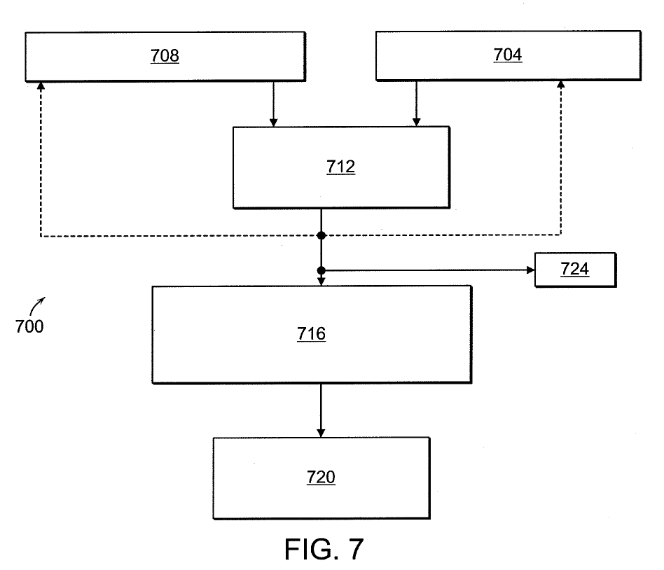

Different numbers of wheels or other ground-contacting members may advantageously be used in various embodiments of the invention as particularly suited to varying applications. FIGS. 6 and 7 of U.S. Patent Publication No. 2006/0108156, incorporated herein by reference, describe a balancing all-terrain vehicle, as an example of a device to which the present invention may advantageously be applied. The all-terrain vehicle has two front wheels and two rear wheels. Each rear wheel is driven by its own actuator. Thus, within the scope of the present invention, the number of ground-contacting members may be any number equal to, or greater than, one.

“Pitch state” as used in this description and the appended claims includes both the pitch in the fore-aft plane and the pitch rate of the vehicle, i.e. θ and θᵣ (or \dot{θ}) where θᵣ is the time rate of change of θ.

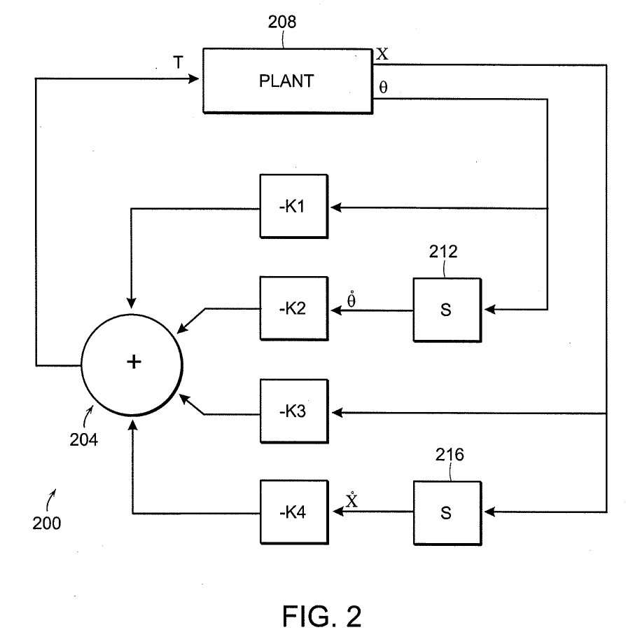

FIG. 2 illustrates a control loop 200 for dynamically maintaining stability of a vehicle (plant 208) in the fore-aft plane so that the vehicle remains upright. This control loop 200 requires the pitch state as an input. U.S. Pat. Nos. 5,701,965 and 5,791,425 describe vehicles that can be operated using the control loop 200 of FIG. 2. The vehicles require measurement of instantaneous pitch state for active control of the vehicles' stability. These patents are incorporated by reference herein in their entirety. The plant 208 of FIG. 1 is equivalent to the equations of motion of a locomotion system driven by a single motor. T identifies the wheel torque. Theta (θ) identifies the fore-aft inclination (i.e., the pitch angle), X identifies the fore-aft displacement along a surface relative to a reference point, and the subscript r denotes a variable differential with respect to time. Control gains K₁, K₂, K₃ and K₄, differentiators 212 and 216 and a summer 204 are used to achieve balance. To achieve dynamic control and to insure stability of the system, and to keep the system in the neighborhood of a reference point on the surface, the wheel torque T in this embodiment is set to satisfy the following equation:

T=K₁θ+K₂θᵣ+K₃X+K₄Xᵣ (EQN. 1)

The values of the gains K₁, K₂, K₃ and K₄ are dependent on settings of the control loop, physical parameters of the system, and other effects such as gravity.

The dynamic behavior of a vehicle may be described through reference to a coordinate system. Two such coordinate systems are used in describing the motion of a vehicle about irregular surfaces: the Earth reference frame, “E-frame”, and the vehicle reference frame “V-frame.”

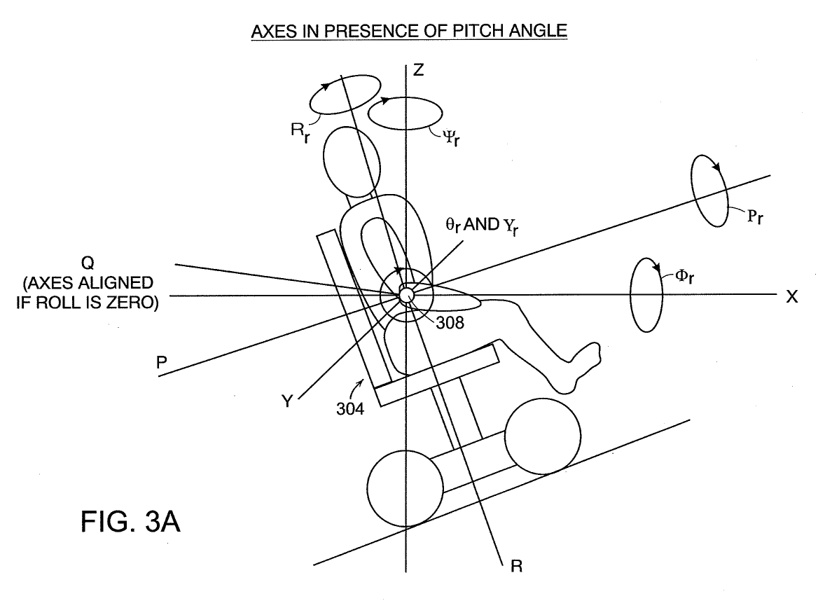

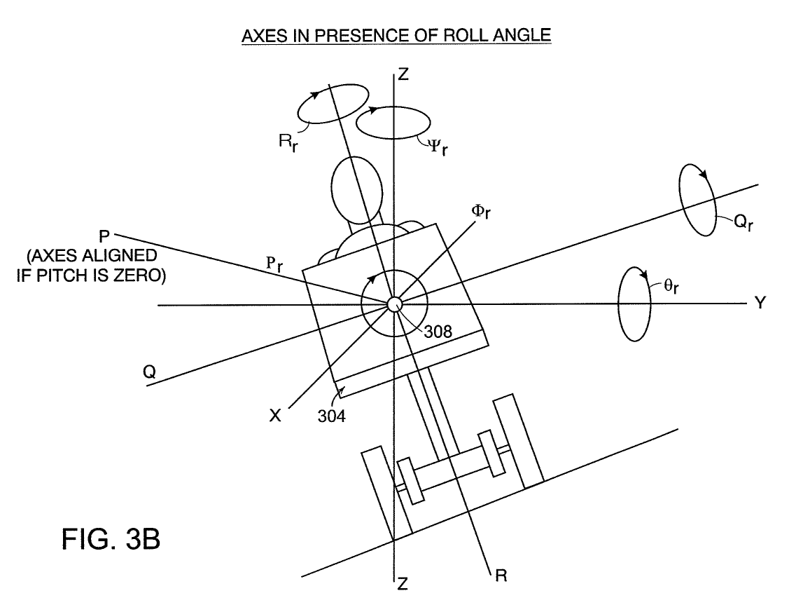

The E-frame defines the vertical axis, Z, to be co-linear to the direction of gravity and passing through the center of gravity 308 of an occupied vehicle 304 as shown in FIG. 3A. The position of the origin of the E-frame axes about the center of gravity 308 is an arbitrary choice and it should be understood by those skilled in the art that the origin may be positioned about other points on the vehicle 304. The E-frame defines the roll axis, X, as a component in the direction of travel perpendicular to the vertical axis and passing through the center of gravity 308 of the occupied vehicle 304, and the E-frame defines the pitch axis, Y, to be orthogonal to both the Z and X axes and passing through the center of gravity 308 of the occupied vehicle 304. Rotation around the Z axis is described by the angle Ψ, also known as the yaw angle. Rotation around the X axis is described by the angle Φ, also known as the roll angle. Rotation around the Y axis is described by the angle θ, also known as the pitch angle.

The axes associated with the V-frame have an origin positioned at the center of gravity 308 of the vehicle 304. In other embodiments, the origin of the axes may be situated at another point on the vehicle 304. The axes are fixed with respect to the vehicle 304. The relative vertical axis, R, is a specified vehicle-fixed substantially vertical axis and may be defined by a line passing through the center of gravity 308 of the vehicle 304 and the support/backrest/head of the operator of the vehicle 304. The relative horizontal axis, P, is perpendicular to the relative vertical axis and has a component parallel to the direction of movement of the vehicle 304. The third axis, Q, is orthogonal to both R and P. The relative orientation of the R, P, Q frame varies with respect to the Z, X, Y frame as the vehicle 304 tilts. As shown in FIG. 3A, the Q and Y axes are co-linear, however, R and Z, and X and P are not co-linear, showing that the vehicle is “pitching” and thus it has a non-zero value for θ. FIG. 3B illustrates the vehicle 304 in the presence of a roll angle. The P and X axes are co-linear, however, the R and Z and Q and Y axes are not co-linear. In this configuration, there is a non-zero roll angle, Φ.

The equations below present the rate transformations between the E-frame and V-frame under a small angle approximation for the respective rotation rates, denoted by the subscript r. These transformations will be referred to as small angle Euler transforms (SAETs) and inverse SAETs respectively.

$$\begin{matrix}[ \begin{matrix}{Φ}_{r} \\ {θ}_{r} \\ Ψ\end{matrix} ] = [ \begin{matrix}1 & θΦ & - θ \\ 0 & 1 & Φ \\ 0 & - Φ & 1\end{matrix} ] [ \begin{matrix}{P}_{r} \\ {Q}_{r} \\ {R}_{r}\end{matrix} ] & EQN . 2 \\ [ \begin{matrix}{P}_{r} \\ {Q}_{r} \\ {R}_{r}\end{matrix} ] = [ \begin{matrix}1 & 0 & θ \\ 0 & 1 & - Φ \\ 0 & Φ & 1\end{matrix} ] [ \begin{matrix}{Φ}_{r} \\ {θ}_{r} \\ {Ψ}_{r}\end{matrix} ] & EQN . 3\end{matrix}$$

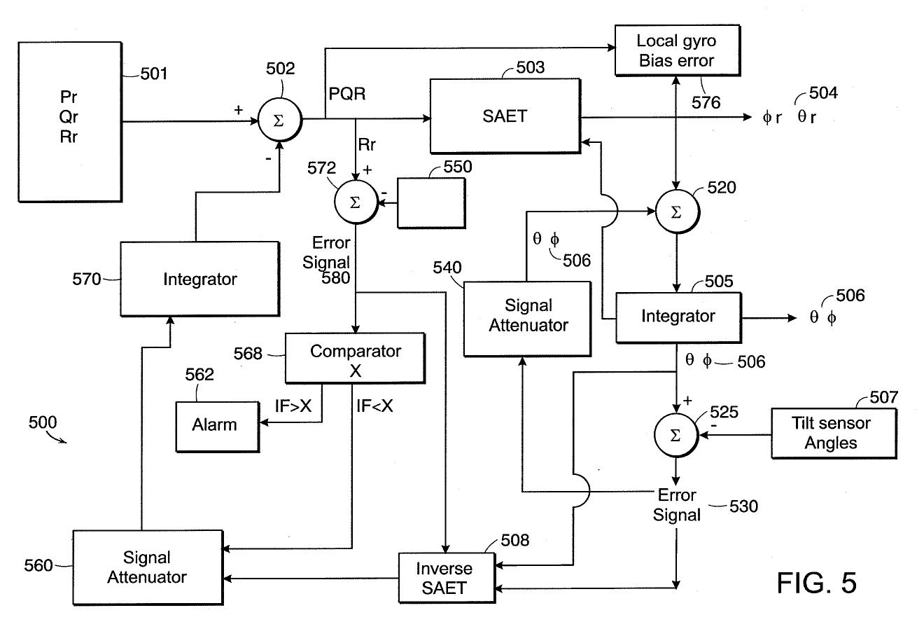

Inertial sensors, for example, such as angular rate sensors or rate gyroscopes (hereinafter referred to as gyros) are used to provide pitch state information to the vehicle 304. The inertial sensors measure the rate of change of the orientation of the vehicle 304 about the V-frame and produce a signal which is representative of the rate of change of the pitch, roll, and yaw angles of the vehicle 304. The inertial sensors need to be adjusted regularly due to sensor drift. Thus, tilt sensors are incorporated into the system for providing a stable angular value from which bias errors of the inertial sensors may be compensated, as is discussed with respect to FIG. 5 below. More than one tilt sensor may be used to provide redundancy in the even of one tilt sensor failing. In one embodiment of the invention, the inertial sensors are gyros. In other embodiments, however, the rate sensor may be any other inertial measurement device. A system for accurately measuring the pitch state based in part on the pitch rate signal obtained from the inertial sensors and the pitch signal from a tilt sensor may be calculated using various transformations as described, for example, below.

In addition, U.S. Pat. No. 6,332,103 describes additional methods and apparatus for measuring and/or estimating the pitch state of a vehicle. This patent is incorporated by reference herein in its entirety.

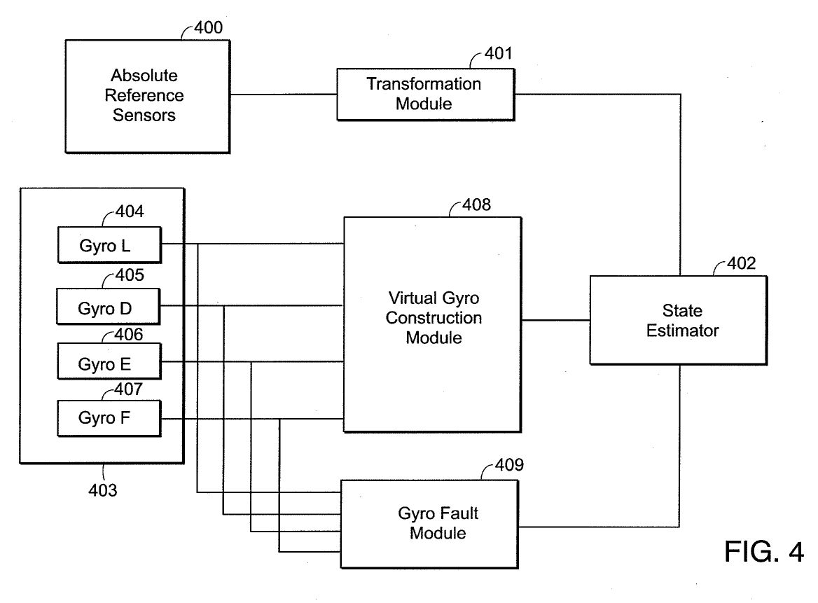

FIG. 4 is a schematic clock diagram of a portion of the system architecture used to control a transporter, according to an illustrative embodiment of the invention. Absolute reference sensors 400 send signals to transformation module 401 where the signal produced by the sensor is converted to a useful digital data format and adjusted for known sources of error. Absolute reference sensors 400 which are a special case of accelerometers include sensors that measure quantities with respect to the E-frame such as pendulous reference sensors, also known as tilt sensors. Absolute reference sensors also include sensors capable of measuring the rotation of the wheels of a vehicle to produce a signal of the difference in wheel velocities.

The transformation module 401 provides to the state estimator 402 information corresponding to the pitch angle and roll angle when the vehicle is unaccelerated except for the force of gravity, and the difference in wheel velocities. The difference in wheel velocities provides an absolute value for the yaw rate assuming the wheels do not slip.

Relative reference sensors 403 measure quantities with respect to the V-frame and may include inertial sensors, for example, gyroscopes such as mechanical or solid-state gyroscopes. In order to provide information on the three orientations, at least three single axes gyroscopes are required. Additional gyroscopes may be used to provide fault-tolerance capability. FIG. 4 shows one embodiment of the invention where the relative reference sensors 403 consists of gyro L 404, gyro D 405, gyro E 406, and gyro F 407. In one embodiment, four one-degree-of-freedom gyroscopes are used. Gyro L 404 may be mounted on the vehicle such that it measures Qᵣ of the vehicle. In such an embodiment, the remaining three gyros 405, 406 and 407 are mounted on the vehicle at various orientations and measure a combination of the Qᵣ, Pᵣ, and Kᵣ. The selection of the mounting orientations serve to balance other factors such as sensor signal range and accuracy. The gyroscopes may be placed on the principle axis of the vehicle, but in one embodiment the gyroscopes are placed off the axis and non-colinear to each other. This provides redundancy among the gyroscopes. If one of the gyroscopes fails, a value for Pᵣ, Qᵣ, or Rᵣ may still be calculated, because the other gyroscopes measure Pᵣ, Qᵣ, and Rᵣ components.

Additionally, the gyroscopes are set off axes in some embodiments because the vehicles capabilities may be greater than the measurement range of the gyroscopes. For example, the angular rate during a sharp turn could be beyond the measurement range of the gyroscopes. By canting the gyroscopes, the measured rate is scaled by the cosine of the angle between the rotation axis and the canted axis and also resulting in the cross coupling of other orthogonal rate components.

The relative reference sensors 403 transform the angular rate sensed into a digital signal of the represented angular rate and pass the signal to a virtual-gyro construction module 408. Because the orientation of the gyroscopes may not be aligned with the Q, P, and R axes, each signal produced by the gyroscope may be comprised of rate information about multiple axes. The virtual gyro construction module 408 transforms the signals to produce three output signals that correspond to the signals that three virtual gyros would produce if oriented to measure the rotation about the P, Q, and R axes. This operation on the gyro signals produces the virtual gyro Pᵣ, Qᵣ and Rᵣ information.

The virtual gyro construction module performs the matrix equation, V=M G where V is the virtual gyro vector, G is the gyro output vector, and M is a 3×4 construction matrix that converts the four gyro signals in G to the virtual gyro vector, V. The construction matrix is not unique and can be the inverse least squares solution, or the output of any one of the four combinations of three of the four gyros or any combination of the solutions. The coefficients of the construction matrix are determined during the calibration of the vehicle and contain both corrections for gyro alignment and for the individual gyro characteristics. In one embodiment, the construction matrix provides greater fault tolerance for gyroscopes D, E, and F through a combination of the solutions selected from the least squares solution and the four three-gyroscope combinations.

A gyro fault detection signal from the gyro fault detection module 409 is also generated from the raw signals, which is passed to the state estimator 402. One embodiment of a fault detection module for use with the present invention is described with respect to FIG. 5 of U.S. Pat. No. 6,332,103, the entirety of which is incorporated by reference herein. In some embodiments, a transporter is operated using an additional fault detection module (described further below with respect to FIGS. 5, 6 and 7) that is used to determine whether one or more angular rate sensors have a signal offset that is undesirable for operation of the transporter. In the event that an undesirable signal offset is detected, a control system for the transporter may alert the user of a fault so that the user does not climb on to the transporter. In some embodiments, the functionality of the additional fault detection module is incorporated into the gyro fault detection module 409.

The state estimator 402 takes the signals from the virtual gyro-construction module 408, the gyro fault detection module 409, and the calibration-transformation module 401 and estimates the pitch state of the vehicle. The state estimator 402 also estimates the roll state and yaw state of the vehicle, but in a preferred embodiment of the invention, only the pitch state of the vehicle is passed on to the control loop for balancing the vehicle about the vehicle's center of gravity.

Although FIG. 4 illustrates the use of four gyros in one embodiment of the invention, any number above three may be used to provide increasing fault-tolerant capability to the system.

FIG. 5 is a functional block diagram for a three axis state estimator module 500, according to an illustrative embodiment of the invention. The rotation rate signals 501, represented by Pᵣ, Qᵣ and Rᵣ from the virtual gyro construction 408, are first passed into a summer 502 which corrects for bias errors through a feedback loop. The corrected rotation rates are coordinate transformed from the V-frame to the E-frame using a small angle Euler transform (SAET) 503 thereby producing the E-frame pitch rate, roll rate, and yaw rate information 504, designated by θᵣ, φᵣ and Ψᵣ. θᵣ is then provided to the control loop of the vehicle. The E-frame rotation rates from the SAET 503 are passed into a summer 520 and are then integrated in the integration module 505 to produce the E-frame orientation angles 506 designated by θ and φ. θ is then passed to the control loop of FIG. 2 of the vehicle. θ and φ are also passed back for use in subsequent SAET transforms in SAET module 503. The integration module 505 at summer 525 takes the difference between θ and the pitch angle 507 and φ and the roll angle 507 respectively to generate pitch and roll error signals 530. The pitch angle and the roll angle 507 are provided by the tilt sensors 400. The error signals 530 are then passed to the inverse Euler transform 508 along with the E-frame orientation angles, θ, φ 506.

The pitch and roll error signals 530 are also fed back and passed through a filter 540 which attenuates the signal's strength. The attenuated signal is passed into the summer 520. The feedback loop is provided to correct for inaccuracies due to transients, so as to move the output readings of 506 in the direction of the tilt sensors. The attenuation of the signal attenuator 540 is provided to limit a large erroneous absolute reference sensor value from affecting the E-frame orientation angles. A large erroneous absolute reference sensor value may occur, for example, where the vehicle goes over a sudden bump. As the vehicle goes over a bump, the absolute reference sensors will produce extraneous signals in the form of transients which inaccurately reflect the pitch rate and the pitch angle.

In the inverse SAET 508 an inverse SAET is performed on the pitch, roll and yaw error information. In this inverse transform the error signals 530 of the pitch and roll are inserted in the inverse equation at θᵣ, φᵣ and the yaw error signal 580 is inserted at Ψᵣ where one would expect to find the respective rates. Ψᵣ is provided from summer 572 as the difference between Rᵣ and the difference in the velocity of the wheels 550. Performing the inverse SAET on the error signals rather than the rates has the effect of partitioning the error information. The inverse SAET transforms the E-frame signals into the V-frame coordinate system. This signal is then passed through an attenuation filter 560. After the attenuation filter 560, the signals are placed in an integrator 570 and then passed back to the summer 502. This feedback loop accounts for the long term bias drift of the gyroscopes. The attenuation filter 560 allows the tilt sensors which are more stable over long periods of time to assist in correcting for the drift of the gyroscopes while still allowing the gyroscopes to control short term changes.

Unlike the Pᵣ and Qᵣ corrections which are proportional to the error signal, the yaw rate, Rᵣ, correction is performed only up to a preset error level designated as X. This comparison is done in comparator 568. If the yaw rate error signal becomes larger than the preset error level X, correction to Rᵣ is suspended under the assumption that the wheels no longer represent the yaw rate and a suspension timer is started. The gyro rate value, Rᵣ is still compared to the delta wheel rate 550 during the suspension to calculate a yaw error signal 580. If after a predetermined amount of time the difference between the value of Rᵣ and that of the delta wheel rate is not below the preset error level, an alarm occurs 562 which in one embodiment is a visual signal. If after a second predetermined time on the suspension timer the difference does not fall below the preset error level, the yaw correction is shut off and an alarm sounds indicating that the system cannot distinguish between a fault and the drift error of the gyroscopes. If the second time limit is reached, the system must be reset. The preset error limit is imposed to prevent erroneous R data from being incorporated into the pitch state estimate when, for example, the vehicle is stationary on a moving platform that is turning.

To provide for accurate readings of the pitch state, upon initialization, the pitch state estimator attempts to align the gyroscopes to the tilt sensor as long as the system is non-accelerated. This is accomplished by adjusting the corner frequencies through the two signal attenuators 540 and 560 to orient the system to the tilt sensors. In one embodiment, this is accomplished by adaptively adjusting the gain in response to an error signal. If during initialization, the gyroscopes and the tilt sensors do not align, the system may pause and then re-measure the values for the tilt sensor and gyroscopes to see if they have aligned. If they do not align, the system may reverse the process and begin again until alignment is achieved.

If a gyro failure is detected, the state estimator 402 performs a single axis estimate of the pitch state which is described in U.S. Pat. Nos. 5,701,965 and 5,791,425. The same components and filters of the three axis state estimator are used in the single axis estimate as shown in FIG. 5. In the case of the single axis estimate, only the pitch rate for a selected gyroscope from the virtual gyro construction module 408 is passed into box 501. A further distinction is that in the single axis state estimator the difference in the velocities of the wheels which provides the yaw rate and rate for the three axis state estimator is used in the single axis state estimator only to assist in compensating for misalignment of the gyroscope for the pitch angle. A limiter is placed on this yaw rate to overcome situations where the wheels slip. In the single axis state estimator the yaw angle derived from the delta wheel velocities is passed to a summer for removing this component from the calculations and is passed into box 501.

Additionally, in box 501 a calibration module is added which corrects for misalignment of the gyroscope. In one embodiment, to provide a smooth transition between the three axis state estimator and the single axis state estimator, the local gyro bias indicator 576 provides an initial condition for the integrator of 570 in single axis mode. Another difference between the three axis state estimator and the single axis estimator is that there is no SAET module 503 and inverse SAET 508 because the single axis state estimator must assume that Q=θᵣ as there is no need to map the pitch in the V frame to the pitch in the E frame as the system is operating in a single plane as opposed to three dimensions. Additionally, the tilt sensor, which is preferably a two axis pendulous sensor, which provides a signal for both the pitch and roll, is only used for the pitch signal and the roll signal is disregarded.

In one embodiment, there are six gyroscopes. Three gyroscopes are configured about the pitch axis of the V frame and the remaining three gyroscopes are set along a combination of the roll and yaw axes of the V frame. In such a fashion, partially triple redundancy is provided. Each gyroscope situated about the pitch axis has an associated processor and tilt sensor the processor capable of providing a single axis state estimate from the associated gyroscope and tilt sensor. The processor receives signals from its associated gyroscope along with the signals from the three gyroscopes which mounted to sense rotation about the yaw and roll axes. The redundancy provides another failsafe system for the vehicle. Each of the three processors independently estimates the pitch state using either the associated gyroscope alone for a single axis state estimate or using both the associated gyroscope and the three remaining gyroscopes for a three axis state estimate. If all the gyroscopes are operating properly, the state estimates produced by the three processors will all agree. However, if one of the associated gyroscopes fails, the state estimates produced by the three processors do not agree. A voting mechanism may be implemented such that the processor producing the erroneous estimate shuts itself off.

Control systems used to operate vehicles typically require one or more powering up/initialization processes that are performed while starting up the vehicle. An initialization process generally insures that the control system and components are ready for operation prior to a user beginning to use (e.g., ride) the vehicle. In some embodiments, during the initialization process, the vehicle control system determines whether the various actuators (e.g., motors for applying torque to the transporter's ground-contacting elements for applying torque to an underlying surface of the transporter) and sensors (e.g., angular rate sensors, tilt sensors, accelerometers) are functioning properly. If the actuators and sensors are functioning properly, the vehicle control system completes the initialization and then notifies a user that the vehicle is functioning properly and ready for use.

Balancing transporters (e.g., the transporter 10 of FIG. 1) are examples of vehicles that benefit from using one or more initialization processes. For example, the transporter 10 of FIG. 1 uses a plurality of angular rate sensors for controlling the operation of the transporter as described above with respect to FIGS. 2, 4 and 5.

FIG. 6 is a schematic illustration of a control system 600 for a transporter for detecting faults in angular rate sensors during startup of a vehicle (e.g., the transporter 10 of FIG. 1), according to an illustrative embodiment of the invention. The control system 600 includes a plurality of devices 604 (e.g., orientation sensors). The devices 604 output orientation signals 616 (e.g., roll angle and rate and pitch angle and rate) associated with a transporter to a processor 620. The control system also includes a plurality of angular rate sensors 612. The angular rate sensors 612 output a plurality of angular rate signals 616 to the processor. The control system 600 also include a controller 628 that is used to, for example, control the pitch of the transporter based on a pitch state estimate 624 generated by the processor 620.

In this embodiment, the processor 620 receives the orientation signals 608, angular rate signals 616 and a variety of other signals as may be necessary to control the operation of the transporter. In one embodiment of the invention, the processor 620 implements the methods described with respect to FIGS. 2, 4 and 5 to control the operation of the transporter. In one embodiment, the control system 600 is used to perform the method described in FIG. 7 below.

FIG. 7 is a flow diagram 700 of a method for initializing and operating a controller of a balancing transporter, according to an illustrative embodiment of the invention. In one embodiment, the method is implemented using the controller 600 of FIG. 6. The method involves acquiring a plurality of orientation signals 704 associated with a balancing transporter (e.g., the transporter 10 of FIG. 1). The method also involves acquiring a plurality of angular rate sensor signals 708 from a plurality of angular rate sensors (e.g., outputs of the gyros 404, 405, 406 and 406 of FIG. 4).

The method also involves determining 712 if one or more of the plurality of angular rate sensor signals output by the angular rate sensors have an offset below a threshold, based on the plurality of orientation signals. If the angular rate sensor signals output by the angular rate sensors have offset below the threshold (e.g., pre-specified by the manufacturer) the controller initializes a pitch state estimator 716 for controlling operation of the transporter. The controller initializes the pitch state estimator 716 based on output of the one or more angular rate sensors. The method also involves controlling the operation of the transporter 720 based on at least one output of the pitch state estimator.

In some embodiments, the threshold is set at a level that is required to ensure pitch state estimator will function properly. At values at or above the threshold, the pitch state estimator will not provide proper pitch state signals and the controller (e.g., controller 628 of FIG. 6) will not be able to properly control the pitch of the transporter during operation. In some embodiments, the threshold is based on the maximum allowable angular rate sensor offset at which the pitch state estimator (e.g., the three-axis estimator module 500 of FIG. 5) can properly function. For example, in some embodiments, the threshold is based on the maximum allowable angular rate sensor offset at which the pitch state estimator is still able to mathematically converge to a pitch state estimate that the controller 628 of FIG. 6 is capable of using to the control the transporter.

Referring to FIG. 7, if the controller determines that one or more of the angular rate sensors has a signal output offset at or above the threshold (step 712), the controller acquires new orientation signals and angular rate signals by repeating steps 704 and 708, respectively. If after a predefined period of time, the controller still determines that one or more of the angular rate sensors has a signal output offset at or above the threshold (step 712), initialization of the pitch state estimator is terminated (step 724). In some embodiments, the controller acquires new orientation signals and angular rate signals for a predefined number of cycles rather than during a predefined period of time.

In some embodiments, the controller repeats steps 704, 708 and 712 until the signal output offsets of the angular rate sensors are below the threshold. This may be a useful operating condition where, for example, a user may be inadvertently moving the body of the transporter during initialization and the angular rate sensors are not actually experiencing a fault (e.g., the angular rate sensors do not actually have an offset greater than a predefined threshold).

In some embodiments, the initialization of the pitch estimator 716 is terminated if one or more of the orientation signals equals or exceeds its corresponding threshold value. In various embodiments of the invention, step 712 above involves one or more of the following steps:
1. determining if pitch or roll of the transporter equals or varies by more than a specified number of degrees over a predetermined period of time, in which the pitch and roll are estimated based on output signals of accelerometers located on the transporter;
2. determining if yaw rate of the transporter equals or varies by more than a specified number of degrees per second over a predetermined period of time, in which the yaw rate is estimated based on difference in speed of left and right ground-contacting elements (e.g., wheels 20 and 21 of FIG. 1) of the transporter that apply torque to an underlying surface of the transporter;
3. determining if speed of a left or right ground-contacting element of the transporter equals or exceeds a specified number of meters per second, in which the left and right ground contacting elements apply torque to an underlying surface of the transporter; and
4. determining if the difference between a first yaw rate signal and a second yaw rate signal is equal to or greater than a specified number of degrees per second, in which the first yaw rate signal is estimated based on difference in speed of left and right ground-contacting elements of the transporter that apply torque to an underlying surface of the transporter and the second yaw rate signal is based on angular rate signals output by two or more of the plurality of angular rate sensors, in which the angular rate signals corresponding to angular rate around a transporter-fixed substantially vertical axis.

In one embodiment of the invention, geometry of the transporter, location of sensors and actuators on the transporter and the ability of the pitch state estimator module 500 of FIG. 5 to converge on a pitch state estimate were used to determine that the angular rate sensor offset threshold for a specific transporter was 20.7 degrees per second. The 20.7 degrees per second threshold was determined based on a stackup of tolerances in the transporter: 10 degrees per second is the estimated offset specified by the manufacturer of the angular rate sensor (a model ADXRS401 angular rate-sensing gyroscope manufactured by Analog Devices, Inc. (Norwood, Mass.) which was calibrated for offset and scale factor variation over temperature); 6.7 degrees per second is the amount of estimated residual motion of the platform of the transporter despite a desire for the platform to be stationary; and 4 degrees per second is the estimated change in offset over the operating lifetime of the transporter.

Further, the following orientation signals associated with the transporter were used to determine if one or more of the plurality of angular rate sensors had a signal output offset below the threshold (20.7 degrees per second):
1. whether pitch or roll of the transporter equaled or varied by more than 1.5 degrees over a approximately 0.3 seconds, in which the pitch and roll were estimated based on output signals of accelerometers located on the transporter. This threshold limit was selected as a residual platform motion of 4.7 degrees per second for each PQR axis. In the absence of abrupt transporter accelerations, the pitch accelerometer and roll accelerometer tests of 1.5 degrees over 0.32 seconds specifies that the average rate on each of the PQR axes would not exceed 4.7 degrees per second (derived from: 1.5 degrees per second divided by 0.32 seconds=4.7 degrees per second). 4.7 degrees per second was arrived at empirically as a compromise between two issues. First, enforcing a low enough platform motion such that motion would be detected such that proper pitch estimation would occur as described, for example, with respect to FIG. 7. Second, the value was also selected to ensure it was not overly restrictive, where values greater than 4.7 degrees per second would require accelerometer and wheel speed sensors to have better accuracies than would be readily available. Further, by enforcing too low a residual motion in the transporter, it would require a user to hold the machine very still before the pitch state estimator would initialize;
2. whether yaw rate of the transporter equaled or varied by more than 4.7 degrees per second over approximately 0.3 seconds, in which the yaw rate was estimated based on difference in speed of left and right ground-contacting elements of the transporter. This threshold limit was set for the same reasons as described above, however, the limit was established for yaw axis motion and was based on the difference between the left and right wheel speed sensors on the motors;
3. whether speed of a left or right ground-contacting element of the transporter equaled or exceeded 0.22 meters per second over approximately 0.3 seconds, in which the left and right ground contacting elements apply torque to an underlying surface of the transporter. This threshold limit value was empirically selected as the wheel speed associated with a user slowly pulling the transporter or rotating the transporter at a rate of less than 4.7 degrees per second;
4. whether the difference between a first yaw rate signal and a second yaw rate signal was equal to or greater than 22 degrees per second, in which the first yaw rate signal was estimated based on difference in speed of left and right ground-contacting elements of the transporter that apply torque to an underlying surface of the transporter and the second yaw rate signal was based on angular rate signals output by two or more of the plurality of angular rate sensors, the angular rate signals corresponding to angular rate around a transporter-fixed substantially vertical axis. This threshold limit value was empirically selected to account for a situation where two rate sensors had sizable offsets (e.g., greater than about 15 degrees per second). Other system operating conditions require that any two rate sensors sensitive to yaw axis motion not have a total offset greater than 29 degrees per second. If two rate sensors having yaw axis sensitivity with a total offset error of greater than 29 degrees per second, the pitch state estimator will no longer produce reliable information for controlling operation of the transporter. A threshold limit of 22 degrees per second was selected to prevent this case from causing detrimental machine behavior.

In various embodiments, the disclosed methods may be implemented as a computer program product for use with a computer system. Such implementations may include a series of computer instructions fixed either on a tangible medium, such as a computer readable medium (e.g., a diskette, CD-ROM, ROM, or fixed disk) or transmittable to a computer system, via a modem or other interface device, such as a communications adapter connected to a network over a medium. The medium may be either a tangible medium (e.g., optical or analog communications lines) or a medium implemented with wireless techniques (e.g., microwave, infrared or other transmission techniques). The series of computer instructions embodies all or part of the functionality previously described herein with respect to the system. Those skilled in the art should appreciate that such computer instructions can be written in a number of programming languages for use with many computer architectures or operating systems.

Furthermore, such instructions may be stored in any memory device, such as semiconductor, magnetic, optical or other memory devices, and may be transmitted using any communications technology, such as optical, infrared, microwave, or other transmission technologies. It is expected that such a computer program product may be distributed as a removable medium with accompanying printed or electronic documentation (e.g., shrink wrapped software), preloaded with a computer system (e.g., on system ROM or fixed disk), or distributed from a server or electronic bulletin board over the network (e.g., the Internet or World Wide Web). Of course, some embodiments of the invention may be implemented as a combination of both software (e.g., a computer program product) and hardware. Still other embodiments of the invention are implemented as entirely hardware, or entirely software (e.g., a computer program product).

Variations, modifications, and other implementations of what is described herein will occur to those of ordinary skill in the art without departing from the spirit and the scope of the invention as claimed. Accordingly, the invention is to be defined not by the preceding illustrative description but instead by the spirit and scope of the following claims.

1. A method for initializing a controller of a balancing transporter, comprising:
a) acquiring a plurality of orientation signals associated with the balancing transporter;
b) determining if one or more of a plurality of angular rate sensors has a signal output offset below a threshold based on the plurality of orientation signals;
c) initializing a pitch state estimator for controlling operation of the balancing transporter based on output of the one or more of the plurality of angular rate sensors; and
d) controlling operation of the balancing transporter based on at least one output of the pitch state estimator.

2. The method of claim 1, comprising terminating step c) if one or more of the angular rate sensors has a signal output offset at or above the threshold.

3. The method of claim 1, wherein step b) comprises comparing each of the orientation signals to a corresponding threshold value.

4. The method of claim 3, wherein the initialization of the pitch state estimator is terminated if one or more of the orientation signals equals or exceeds its corresponding threshold value.

5. The method of claim 3, wherein step b) comprises determining if pitch or roll of the transporter varies by more than 1.5 degrees over a predetermined period of time, the pitch and roll are estimated based on accelerometer output signals.

6. The method of claim 3, wherein step b) comprises determining if yaw rate of the transporter varies by more than 4.7 degrees per second over a predetermined period of time, the yaw rate is estimated based on difference in speed of left and right ground-contacting elements of the transporter that apply torque to an underlying surface of the transporter.

7. The method of claim 3, wherein step b) comprises determining if speed of a left or right ground-contacting element of the transporter exceeds 0.22 meters per second, the left and right ground contacting elements apply torque to an underlying surface of the transporter.

8. The method of claim 3, wherein step b) comprises determining if the difference between a first yaw rate signal and a second yaw rate signal is greater than 22 degrees per second, the first yaw rate signal is estimated based on difference in speed of left and right ground-contacting elements of the transporter that apply torque to an underlying surface of the transporter and the second yaw rate signal is based on angular rate signals output by two or more of the plurality of angular rate sensors, the angular rate signals corresponding to angular rate around a transporter-fixed substantially vertical axis.

9. The method of claim 1, comprising repeating the steps of claim 1 until the signal output offsets of the angular rate sensors are below the threshold.

10. A balancing transporter, comprising:
a plurality of devices for providing orientation signals associated with the balancing transporter;
a plurality of angular rate sensors;
a processor,
a) for determining if one or more of the plurality of angular rate sensors has a signal output offset that equals or exceeds a threshold based on the orientation signals, and
b) for estimating a pitch state of the balancing transporter based on output of two or more of the plurality of angular rate sensors; and
a controller for controlling operation of the balancing transporter based on the pitch state estimate.

11. The transporter of claim 10, wherein the processor determines if one or more of the angular rate sensors has a signal output offset that equals or exceeds a threshold by comparing each of the orientation sensor signals to a corresponding threshold value.

12. The transporter of claim 10, comprising at least one ground-contacting element for applying torque to an underlying surface of the transporter.
